(19) United States
(12) Patent Application Publication
(10) Pub. No.: US 2007/0252460 A1
(43) Pub. Date: Nov. 1, 2007

(54) Blower structure

(75) Inventor: Chih-Ming Cheng, Taipei (TW)

Correspondence Address: HDSL, 4331 STEVENS BATTLE LANE, FAIRFAX, VA, 22033, US

(73) Assignee: Act-rx Technology Corporation

(21) Appl. No.: 11/413,084

(22) Filed: Apr. 28, 2006

(51) Int. Cl. H02K 7/00; H02K 5/16

(52) U.S. Cl. 310/90; 310/67 R; 417/354; 417/423.12

(57) ABSTRACT

A blower includes a hollow casing having ventilating ports, a rotor formed by circumferentially arranging a plurality of blades, and a stator. The rotor is provided at one side along its axial direction with a base plate, and provided at the other side with a magnetic ring seat. The interior of the magnetic ring seat is formed with an accommodating region. The inner wall of the accommodating region is provided with a magnetic ring. The stator is located in the accommodating region and spaced apart form the magnetic ring. The rotor is provided with a ceramic spindle on its base plate and the magnetic ring seat, respectively, so that the rotor can be pivoted in the casing. With the wear-resistant property of both ceramic spindles, the working hours and life of the blower can be increased.

### BACKGROUND OF THE INVENTION

1. Field of the Invention

The present invention relates to an improved structure of a blower, and in particular, the spindle of the blower is made of ceramic materials to increase the working hours and the life of the blower.

2. Description of Prior Art

The spindle of the conventional blower is mostly made of metallic material and is pivoted with the ball bearings. Such structure inevitably causes a great noise during the operation of the blower. Further, the wear of the spindle becomes much worse, causing the difficulty in obtaining a longer working hour or life. Thus, it is necessary to solve the above problems. In view of the above, the inventor proposes the present invention to overcome the above problems based on his expert experiences and deliberate researches.

### SUMMARY OF THE INVENTION

The present invention is to provide an improved structure of a blower, in which the spindle of the blower is made of ceramic material to increase the working hours and life of the blower. Further, the convex abutment between the spindle and the bearing is used to reduce the noise generated during the operation of the blower. With the above structure, the drawbacks of prior art can be solved

The present invention provides an improved structure of a blower, comprising a hollow casing having ventilating ports, a rotor formed by circumferentially arranging a plurality of blades, and a stator. The rotor is provided at one side along its axial direction with a base plate, and at the other side with a magnetic ring seat. The interior of the magnetic ring seat is formed with an accommodating region. The inner wall of the accommodating region is provided with a magnetic ring. The stator is located in the accommodating region and spaced apart form the magnetic ring. The rotor is provided with a ceramic spindle on its base plate and the magnetic ring seat, respectively, so that the rotor can be pivoted in the casing. Each of both ceramic spindles has a convex abutment end. Two bearings are provided between the casing and the rotor. A concave surface is provided on each of both bearings, so that the abutment ends of the two ceramic spindles can abut into the concave surfaces. With the wear-resistant property of both ceramic spindles and the convex abutment between the spindle and the bearing, the above objects can be achieved.

### BRIEF DESCRIPTION OF THE DRAWINGS

FIG. 1 is an exploded perspective view showing the first embodiment of the present invention;

FIG. 2 is an assembled cross-sectional view showing the first embodiment of the present invention;

FIG. 3 is an assembled cross-sectional view showing the second embodiment of the present invention; and

FIG. 4 is an assembled cross-sectional view showing the third embodiment of the present invention.

### DETAILED DESCRIPTION OF THE INVENTION

In order to make the Examiner better understand the characteristics and the technical contents of the present invention, a detailed description relating to the present invention will be made with reference to the accompanying drawings. However, it should be understood that the drawings are illustrative but not used to limit the scope of the present invention.

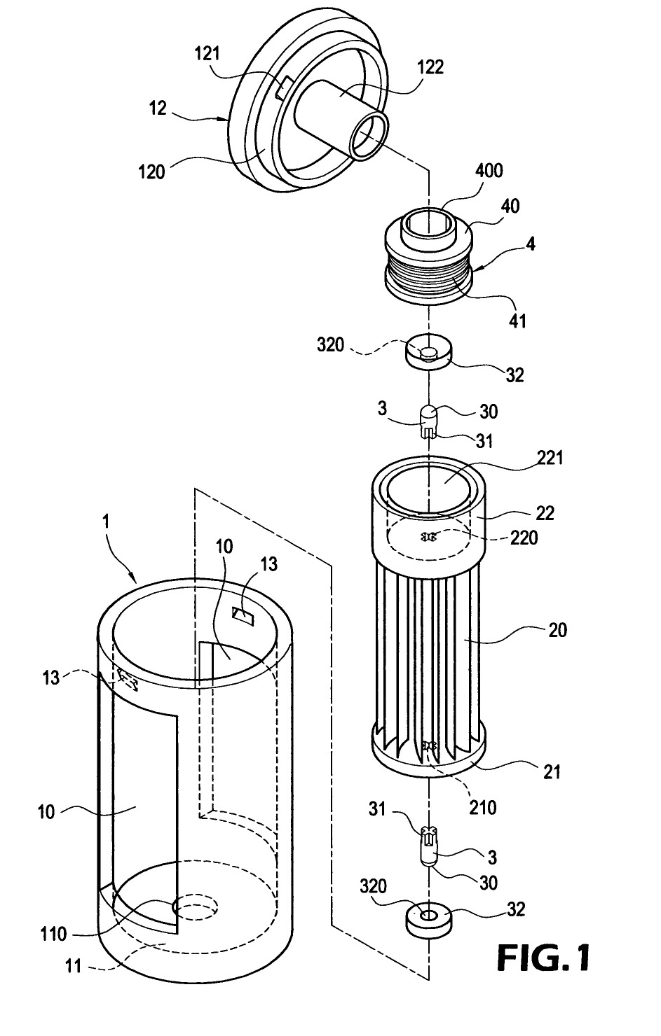

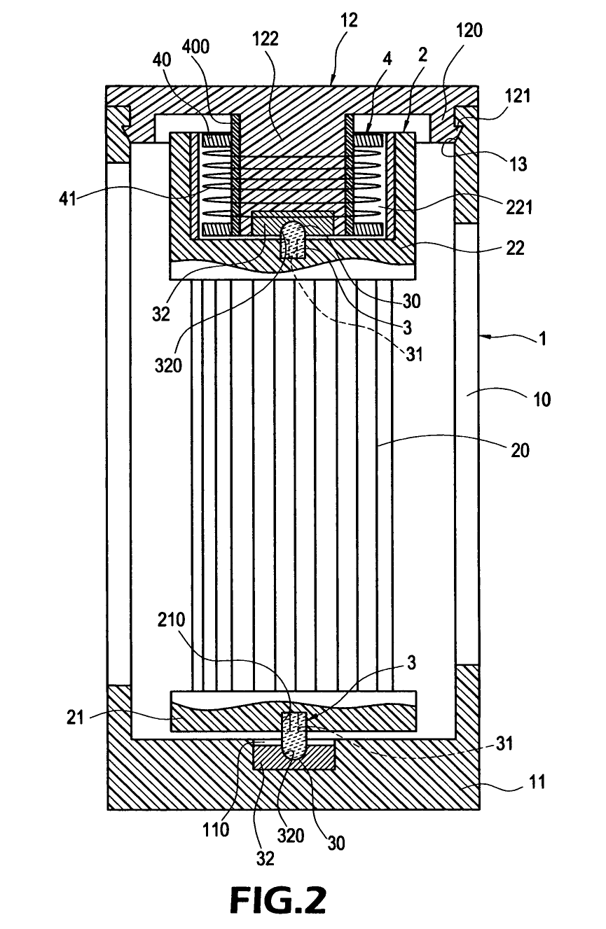

With reference to FIG. 1 and FIG. 2, which are an exploded perspective view and an assembled cross-sectional view showing the first embodiment of the present invention, respectively. The present invention provides an improved structure of a blower, which mainly comprises a casing 1, a rotor 2 and a stator 4.

The interior of the casing 1 is hollow, so that the rotor 2 and the stator 4 can be assembled therein. The casing 1 is cylindrical in shape and provided with ventilating ports 10. One end of the cylindrical casing 1 is a sealed sidewall 11. The other end is open and can be covered by a side cover 12. The inner wall of the side cover 12 is provided with an annular flange 120 for being inserted into the opening of the casing 1. On the annular flange 120, an inclined locking block 121 is provided. Accordingly, the corresponding inner wall of the casing I is provided with a locking notch 13 for being inserted by the locking block 121. In this way, the side cover 12 can be covered on the opening of the casing 1.

The rotor 2 is formed by circumferentially arranging a plurality of blades 20. Along its axial direction, the rotor 2 is provided at one side with a base plate 21, and provided at the other side with a magnetic ring seat 22. The magnetic ring sear 22 is recessed inwardly from the outside to form an accommodating region 221. The inner wall of the accommodating region 211 is provided with a magnetic ring.

The stator 4 comprises a coil seat 40 and a coil 41 wound on the coil seat 40. A positioning hole 400 is provided to penetrate the center of the coil seat 40. Since the connection between the stator 4 and the associated circuit belongs to prior art and is not within the scope of the present invention. The description thereof is thus omitted.

In the present invention, two spindles 3 are used to serve as a pivoting mechanism between the casing 1 and the rotor 2. Further, since the two spindles 3 are made of ceramic materials, the wear-resistant property of the ceramic material is used to increase the working hours and life of the blower. The inner wall of the side cover 12 is further provided in the annular flange 120 with a positioning post 122 for fixing the coil seat 40 of the stator 4 on the positioning post 122 of the side cover 12 via a positioning hole 400. At the same time, the stator 4 can be arranged in the accommodating region 221 of the magnetic ring seat 22 of the rotor 2, so that the stator and the magnetic ring of the magnetic ring seat 22 can be spaced apart to produce magnetic inductance after supplying electric power to the stator 4, thereby to cause the rotation of the rotor 2.

According to the above, in the present embodiment, the rotor 2 is provided at the center of its base plate 21 with a first spindle hole 210, and is provided at the center of the bottom surface of the accommodating region 221 of the magnetic ring seat 22 with a second spindle hole 220. Therefore, the two ceramic spindles 3 can be inserted and fixed into the first and second spindle holes, respectively. Further, each of both ceramic spindles 3 has a convex abutment end 30 and an insertion end 31 mating with the spindle hole 210, 220. The insertion end 31 of each ceramic spindle 3 is used to insert into the first and second spindle holes 210, 220, respectively. The insertion end 31 mates with the spindle holes 210, 220 by means of a non-circular construction (e.g. a cross-shaped construction). The abutment end 30 abuts against a metallic or ceramic bearing 32, and the bearing 32 is recessed to form with a concave surface 320 for being abutted by the abutment end 30. Both bearings 32 are provided on the sidewall 11 of the casing 1 and the inner wall of the side cover 12, respectively. Further, bearing holes 110 are provided on the sidewall 11 and the inner wall of the side cover 12 for arranging the bearing 32 therein.

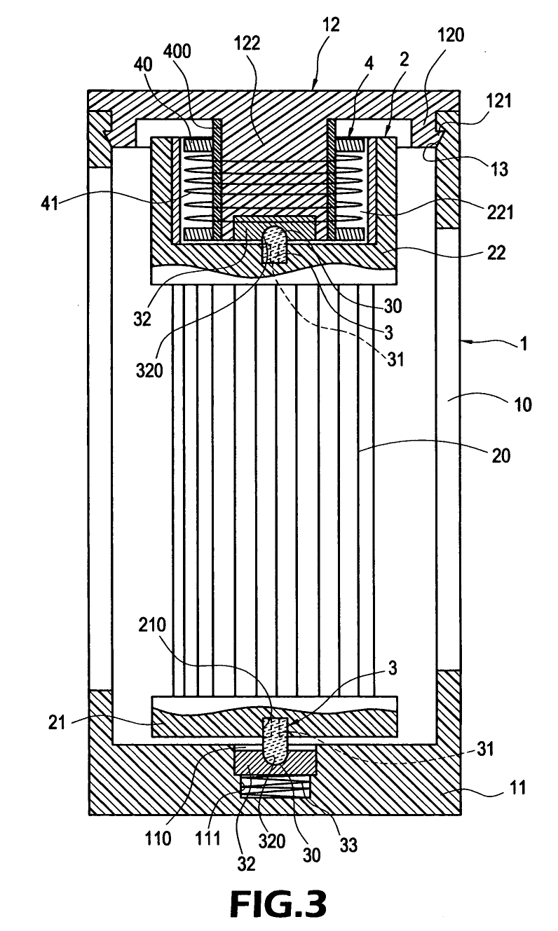

As shown in FIG. 3, the bearing hole 110 can be further recessed inwardly to form a recessed trough 111 for arranging an elastic element 33 therein. The elastic element 33 can be a spring for abutting between the recessed trough 111 and the bearing 32 to provide an elastic and vibration-attenuating effect during the pivoting of the rotor 2 and the casing 1. As a result, the impact and damage of the ceramic spindle 3 caused by external impact forces can be reduced.

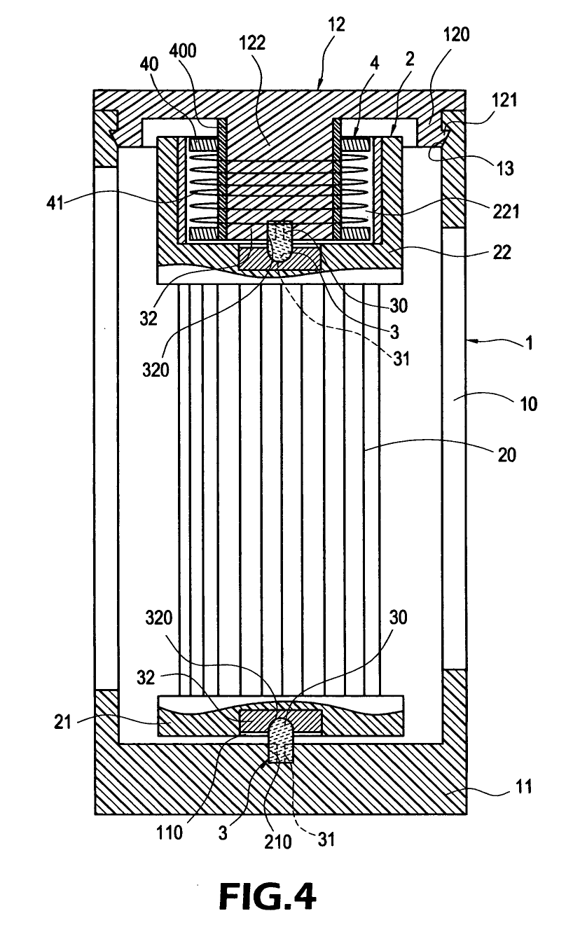

Further, as shown in FIG. 4, the first and second spindle holes 210, 220 can be provided on the sidewall 11 of the casing 1 and the inner wall of the side cover 12, respectively. The bearing hole 110 is provided on the base plate 21 and the magnetic ring seat 22 of the rotor 2, so that both ceramic spindles 3 can be pivoted between the casing 1 and the rotor 2. In this way, the object of the present invention can be also achieved.

Therefore, with the above construction, the improved structure of a blower in accordance with the present invention can be obtained.

In the present invention, since the spindle 3 is made of ceramic material and thus has a higher wear-resistant property and longer life. Further, the abutment end 30 of the ceramic spindle 3 abuts against the bearing 32, and the convex abutment end 30 mates with the concave surface 320 of the bearing 32. In this way, the noise generated during the operation of the blower can be greatly reduced, thereby effectively solved the drawbacks and problems of prior art.

According to the above, the present invent indeed achieves the desired effects and overcomes the drawbacks of prior art by employing the above structures. Therefore, the present invention involves the novelty and inventive steps, and conforms to the requirements for a utility model patent.

Although the present invention has been described with reference to the foregoing preferred embodiments, it will be understood that the invention is not limited to the details thereof. Various equivalent variations and modifications can still be occurred to those skilled in this art in view of the teachings of the present invention. Thus, all such variations and equivalent modifications are also embraced within the scope of the invention as defined in the appended claims.

What is claimed is:

1. A blower, comprising:
a hollow casing having ventilating ports;
a rotor formed by circumferentially arranging a plurality of blades, the rotor provided at one side along an axial direction thereof with a base plate and at the other side with a magnetic ring seat, the magnetic ring seat being formed with an accommodating region therein, the inner wall of the accommodating region being provided with a magnetic ring; and
a stator comprising a coil seat and a coil wounded on the coil seat, the stator assembled in the casing and further arranged in the accommodating region of the magnetic ring seat of the rotor to space apart from the magnetic ring,
wherein the base plate and the magnetic ring seat of the rotor are each provided with a ceramic spindle for pivoting the rotor in the casing, both ceramic spindles have a convex abutment end, two bearings are provided between the casing and the rotor, and both bearings are each recessed to form a concave surface for being abutted by the abutment end of the ceramic spindle.

2. The structure according to claim 1, wherein one end of the casing is a sealed sidewall and the other end is open, and a side cover is provided on the opening of the casing.

3. The blower structure according to claim 2, wherein the casing is provided at the center of the sidewall with a first spindle hole, and provided at the center of the side cover with a second spindle hole, so that the two ceramic spindles are capable of being inserted into the first and second spindle holes, respectively.

4. The blower according to claim 2, wherein the rotor is provided at the center of its base plate with a first spindle hole, and provided at the center of the bottom surface of the accommodating region of the magnetic ring seat with a second spindle hole, so that the two ceramic spindles are capable of being inserted into the first and second spindle holes, respectively.

5. The blower according to claim 2, wherein the inner wall of the side cover is provided with an annular flange, the annular flange is provided with an inclined locking block, a locking notch is provided on the corresponding inner wall of the casing, so that the locking block is capable of being inserted into the locking notch.

6. The blower according to claim 2, wherein the stator further comprises a positioning hole to penetrate the center of the coil seat and a positioning post on the inner wall of the side cover of the casing for fixing the coil seat on the positioning post via the positioning hole.

7. The blower according to claim 1, wherein the casing is recessed to form two bearing holes for arranging the two bearings therein.

8. The blower according to claim 7, wherein the bearing hole is further recessed inwardly to form a recessed trough, and an elastic element is provided in the recessed trough for abutting between the recessed trough and the bearing.

9. The blower according to claim 8, wherein the elastic element is a spring.
